(19) United States
(12) Patent Application Publication
(10) Pub. No.: US 2013/0310282 A1
(43) Pub. Date: Nov. 21, 2013

(54) Wellbore Servicing Fluids and Methods of Making and Using Same

(71) Applicants: Dhanashree Gajanan KULKARNI, Pune (IN); Shadaab Syed MAGHRABI, Thane (IN); Kushabhau Dagadu TEKE, Pune (IN)

(72) Inventors: Dhanashree Gajanan KULKARNI, Pune (IN); Shadaab Syed MAGHRABI, Thane (IN); Kushabhau Dagadu TEKE, Pune (IN)

(73) Assignee: HALLIBURTON ENERGY SERVICES, INC., Houston, TX (US)

(21) Appl. No.: 13/476,782

(22) Filed: May 21, 2012

(51) Int. Cl. C09K 8/32; C09K 8/08

(52) U.S. Cl. 507/110; 507/131

(57) ABSTRACT

A method of servicing a wellbore comprising placing an invert emulsion drilling fluid having an oleaginous continuous phase, a non-oleaginous discontinuous phase, and a fluid loss additive into a wellbore wherein the fluid loss additive comprises a quaternary ammonium compound containing at least one ester linkage. A method of servicing a wellbore comprising introducing a clay-free invert emulsion drilling fluid comprising distearoylethyl dimonium chloride to the wellbore. A wellbore servicing fluid comprising an invert emulsion drilling fluid having an oleaginous continuous phase, a non-oleaginous discontinuous phase, and a fluid loss additive into a wellbore wherein the fluid loss additive comprises an esterquat characterized by Structure A:

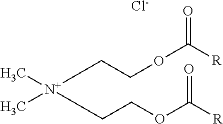

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present disclosure generally relates to wellbore servicing fluids and methods of making and using same. More particularly, this disclosure relates to fluid loss additives having improved biodegradability.

### BACKGROUND

Natural resources such as gas, oil, and water residing in a subterranean formation or zone are usually recovered by drilling a wellbore down to the subterranean formation while circulating a drilling fluid in the wellbore. After terminating the circulation of the drilling fluid, a string of pipe, e.g., casing, is run in the wellbore. The drilling fluid is then usually circulated downward through the interior of the pipe and upward through the annulus, which is located between the exterior of the casing and the walls of the wellbore. Next, primary cementing is typically performed whereby a cement slurry is placed in the annulus and permitted to set into a hard mass, thereby attaching the string of pipe to the walls of the wellbore and sealing the annulus. Subsequent secondary cementing operations such as squeeze cementing may also be performed.

Fluid loss additives (FLA) are chemical additives used to control the loss of fluid (e.g., drilling fluid) to the formation through filtration. In wellbore servicing operations, loss of fluid to the formation can detrimentally affect the performance of wellbore servicing fluids, the permeability of the formation, and the economics of the wellbore servicing operations. Fluid loss additives are sometimes formulated from materials that may be deemed environmentally unacceptable for use in locations subject to stringent environmental regulations. Their status as unacceptable environmental materials may stem from their inability to undergo complete biodegradation which can result in undesirable effects if the materials are released into the environment or if they accumulate in animal and plant tissues for long periods. Thus, there exists a need for a biodegradable fluid loss additive.

### SUMMARY

Disclosed herein is a method of servicing a wellbore comprising placing an invert emulsion drilling fluid having an oleaginous continuous phase, a non-oleaginous discontinuous phase, and a fluid loss additive into a wellbore wherein the fluid loss additive comprises a quaternary ammonium compound containing at least one ester linkage.

Also disclosed herein is a method of servicing a wellbore comprising introducing a clay-free invert emulsion drilling fluid comprising distearoylethyl dimonium chloride to the wellbore.

Also disclosed herein is a wellbore servicing fluid comprising an invert emulsion drilling fluid having an oleaginous continuous phase, a non-oleaginous discontinuous phase, and a fluid loss additive into a wellbore wherein the fluid loss additive comprises an esterquat characterized by Structure A:

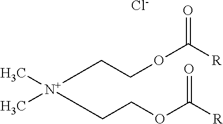

### BRIEF DESCRIPTION OF THE DRAWINGS

For a more complete understanding of the present disclosure and the advantages thereof, reference is now made to the following brief description, taken in connection with the accompanying drawings and detailed description:

FIG. 1 is a depiction of the microbial degradation pathway of an esterquat.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein are wellbore servicing fluids (WSF) comprising fluid loss additives and methods of using same. In an embodiment, the fluid loss additive is biodegradable. In an embodiment, the fluid loss additive has a biodegradability of at least 60% over 28 days as determined in accordance with method OECD 301B. Hereinafter fluid loss additives having a biodegradability of at least 60% over 28 days as determined in accordance with method OECD 301B are termed biodegradable fluid loss additives (B-FLA).

In an embodiment, the B-FLA comprises a cationic surfactant, alternatively a quaternary ammonium compound. In an embodiment, the B-FLA comprises a quaternary ammonium compound comprising at least two fatty acid chains wherein the fatty acid chains are linked to the molecule via cleavable ester linkages. Herein a “cleavable ester linkage” refers to an ester linkage susceptible to bond breaking as catalyzed by enzymes or natural biodegradation mechanism or catalyzed by chemical means such as acid, alkali, UV light, heat or ozone. Collectively compounds comprising a quaternary ammonium moiety having at least two fatty acid chains wherein the fatty acid chains are linked to the molecule via cleavable ester linkages are termed “esterquats.” Esterquats suitable for use in this disclosure may be obtained using any suitable methodology. For example, esterquats suitable for use in the present disclosure may be obtained by an esterification reaction carried out with tertiary alkanolamines and fatty acids. Alternatively, the esterquat can be prepared from sugar derivatives or derived from aminocarboxylic acids.

In an embodiment, an esterquat suitable for use in the present disclosure is characterized by the following general formula I:

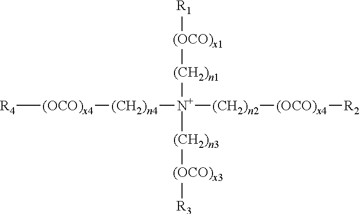

wherein R₁, R₂, R₃ and R₄ are selected from the group consisting of hydrogen; hydroxyl group; saturated or unsaturated alkyl groups; cyclic alkyl groups; aromatic groups; alkyl-aryl groups; and heterocyclic groups or sugar groups containing from about 1 to 36 carbon atoms. In an embodiment, at least two of the R groups, each will comprise more than 12 carbon atoms. In an embodiment, A⁻ can be any counter ion compatible of rendering the molecule neutral. In an embodiment, the counter ion comprises a halide such as fluoride, chloride, bromide or iodide; sulfates such as bisulfate, an alkyl sulfate with the alkyl group comprising less than 4 carbon atoms, and aryl sulfate with the aryl group comprising less than 8 carbon atoms; sulfonates such as alkyl sulfonate, and aryl sulfonate; phosphate ions; carboxylate ions such as, citrate, formate, and acetate; hydroxyl ion; or mixtures thereof. Alternatively, A⁻ comprises halide ions, sulfate ions, sulfonate ions, nitrate ions, carboxylate ions, hydroxyl ions, or phosphate ions. In an embodiment, any of x₁, x₂, x₃, and x₄ can have a value of from about 0 to about 1 and any of n₂, n₃, or n₄ can have a value of from about 0 to about 18. In an embodiment, when any of n₁, n₂, n₃, or n₄ are zero then any of x₁, x₂, x₃, and x₄ is zero provided that not more than two of n₁, n₂, n₃, and n₄ are zero at any one time. In such an embodiment, any of R₁, R₂, R₃ and R₄ is hydrogen and the nitrogen is directly bonded to hydrogen. In an alternative embodiment, any of x₁, x₂, x₃, or x₄ is zero provided that not all of x₁, x₂, x₃, and x₄ are zero at the same time. In such an embodiment, R₁, R₂, R₃ and R₄ may each independently bond directly to the carbon of (CH₂)ₙ. One of ordinary skill in the art will readily understand for the structures described herein each n, x and R group having the same subscript are said to be corresponding to one another. For example R₁ may have a corresponding x₁ and corresponding n₁ as is readily apparent from the general formulas provided herein.

In an embodiment, an esterquat suitable for use in the present disclosure is characterized by the following general formula II:

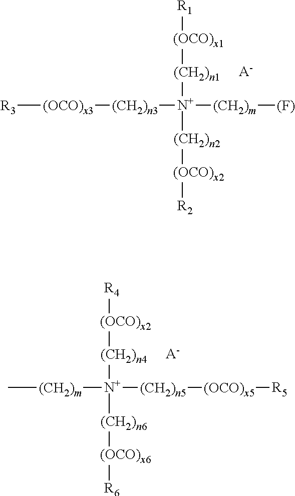

where R₁, R₂, R₃, R₄, R₅ and R₆ are selected from the group consisting of hydrogen; hydroxyl group; saturated or unsaturated alkyl groups; cyclic alkyl groups; aromatic groups; alkyl-aryl groups; and heterocyclic groups or sugar groups containing from about 1 to about 36 carbon atoms. In an embodiment, at least two of the R groups, each will comprise more than 12 carbon atoms. In an embodiment, A⁻ comprises halide ions, sulfate ions, sulfonate ions, nitrate ions, carboxylate ions, hydroxyl ions or phosphate ions all of the type previously disclosed herein. In an embodiment, F comprises an ester group, an ether group, an amide group, an imide group, an amine group, a ketonic group, heterocyclic group, a cyclic alkyl group, an unsaturated alkyl group, an aryl group, a sugar group or combinations thereof. In an embodiment, F is absent and then the (CH₂)ₘ carbons are directly bonded to each other. In an embodiment, any of x₁, x₂, x₃, x₄, x₅, and x₆ can have a value from about 0 to about 1 and any of n₁, n₂, n₃, n₄, n₅, or n₆ and m can have a value of from about 0 to about 18. In an embodiment, when any of n₁, n₂, n₃, n₄, n₅, or n₆ are zero then any of x₁, x₂, x₃, x₄, x₅, and x₆ is zero provided that not more than four of n₁, n₂, n₃, n₄, n₅, or n₆ are zero at any one time. In such an embodiment, R may be hydrogen and the nitrogen is directly bonded to hydrogen. In an alternative embodiment, the value of x₁, x₂, x₃, x₄, x₅, or x₆ is zero provided that not all of x₁, x₂, x₃, x₄, x₅, and x₆ are zero at the same time. In such an embodiment, R₁, R₂, R₃, R₄, R₅ and R₆ may bond directly to the carbon of (CH₂)ₙ.

In an embodiment, an esterquat suitable for use in the present disclosure is characterized by the following general formula III:

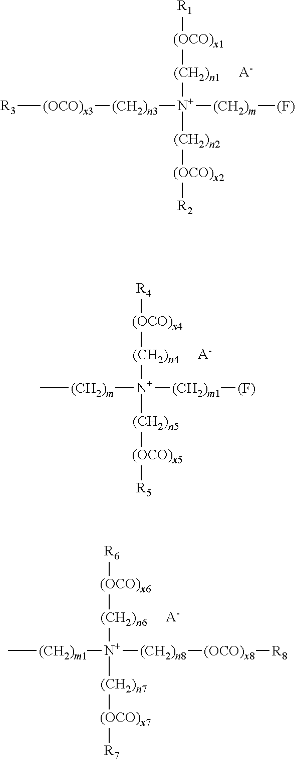

where R₁, R₂, R₃ R₄, R₅, R₆, R₇ and R₈ are selected from the group consisting of hydrogen; hydroxyl group; saturated or unsaturated alkyl groups; cyclic alkyl group; aromatic group; alkyl-aryl groups; and heterocyclic groups or sugar groups containing from about 1 to about 36 carbon atoms. In an embodiment, at least three of the R groups, each will comprise more than 12 carbon atoms. In an embodiment, A⁻ comprises halide ions, sulfate ions, sulfonate ions, nitrate ions, carboxylate ions, hydroxyl ions or phosphate ions, all of the type described previously herein. In an embodiment, F comprises an ester group, an ether group, an amide group, an imide group, an amine group, a ketonic group, heterocyclic group, a cyclic alkyl group, an unsaturated alkyl group, an aryl group, a sugar group or combinations thereof In an embodiment, F is absent and then the (CH₂)ₘ carbons are directly bonded to each other. In an embodiment, any of x₁, x₂, x₃, x₄, x₅, x₆, x₇ and x₈ can have a value from about 0 to about 1 and any of n₁, n₂, n₃, n₄, n⁵, n₆, n₇, n₈, m and m₁ can have a value of from about 0 to about 18. In an embodiment, when any of n₁, n₂, n₃, n₄, n₅, n₆, n₇, and n₈ are zero then any of x₁, x₂, x₃, x₄, x₅, x₆, x₇ and x₈ is zero provided that not more than five of n₁, n₂, n₃, n₄, n₅, n₆, n₇, and n₈ are zero at any one time. In such an embodiment, R may be hydrogen and the nitrogen is directly bonded to hydrogen. In an alternative embodiment, the value of any of x₁, x₂, x₃, x₄, x₅, x₆, x₇ and x₈ is zero provided that not all of x₁, x₂, x₃, x₄, x₅, x₆, x₇ and x₈ are zero at the same time. In such an embodiment, R₁, R₂, R₃ R₄, R₅, R₆, R₇ and R₈ may bond directly to the carbon of (CH2)n. 100181 Alternatively, the quaternary ammonium compound used in the present disclosure is a C18 quaternary ammonium compound with ester linkages characterized by Structure A.

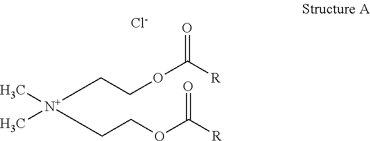

In Structure A, R can be any of the R groups described for R₁, R₂, R₃ and R₄ of general formula 1.

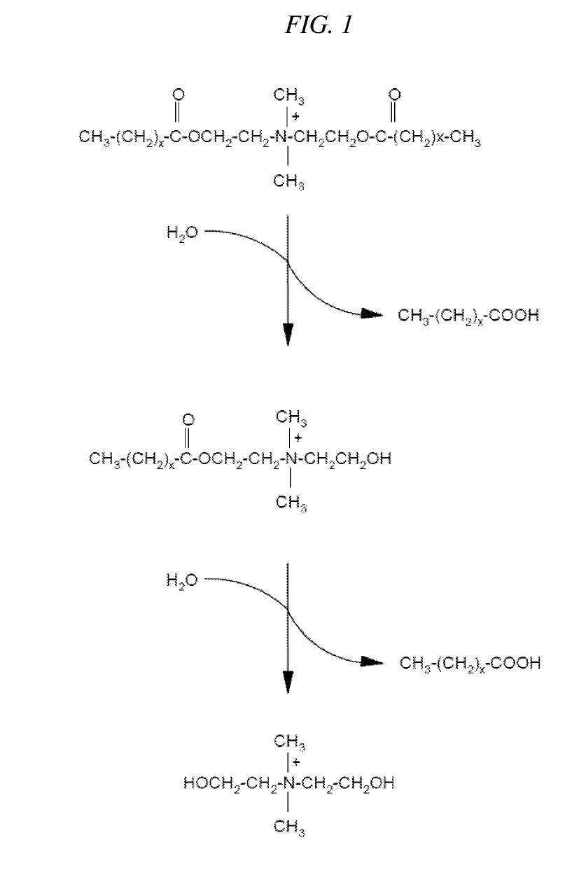

In an embodiment, an esterquat suitable for use in the present disclosure provides at least 60% biodegradability in 28 days as determined in accordance with method OECD 301B, alternatively at least 65%, 70%, 75%,80%, 90% or 100%. Without wishing to be limited by theory, a proposed mechanism for microbial degradation of an esterquat of the type disclosed herein is depicted in FIG. 1. Referring to FIG. 1, hydrolysis of the ester bonds of the esterquat, giving rise to fatty acids and a polyalcohol quaternary ammonium salt represents a general biodegradation mechanism for esterquats. The quaternary ammonium alcohols are thought to be degraded by other microorganisms. The general biodegradation mechanism for esterquats is described in additional detail in a report entitled “Esterquats: Environmental Risk Assessment Report” edition 1.0 dated March 2008 which is incorporated by reference herein in its entirety.

In an embodiment, an esterquat suitable for use in the present disclosure may be a mixture of a compound of the type represented by Formula I and one or more processing aids such as a compounding agent. For example, the esterquat may be provided as a mixture of the compound of the type represented by Formula I and a fatty alcohol such as cetyl alcohol or stearyl alcohol. Such processing aids may be present in the mixture in amounts that comprise greater than about 10 weight percent (wt. %), alternatively greater than about 15 wt. %, alternatively greater than about 20 wt. %, alternatively greater than about 25 wt. % or alternatively greater than about 35 wt. % of the total weight of the mixture. In an embodiment, the processing aid is present in an amount of less than about 50 wt. % of the mixture. In yet another embodiment, an esterquat suitable for use in the present disclosure consists or consists essentially of a compound of the type represented by Formula I.

In an embodiment, an esterquat suitable for use in the present disclosure is VARISOFT® EQ 65 which is an esterquat based on high purity stearic acid compounded with cetearyl alcohol (mixture of cetyl-stearyl alcohol) and is commercially available from Evonik Industries AG Personal Care, Procter & Gamble (DEEDMAC) and Akzo Nobel (ARMOCARE VGH-70). VARISOFT® EQ 65 is comprised of distearoylethyl dimonium chloride and cetearyl alcohol.

In an embodiment, an esterquat of the type disclosed herein can be introduced to a wellbore servicing fluid and function as a B-FLA. In an embodiment, the wellbore servicing fluid is a non-aqueous wellbore servicing fluid. As used herein, a non-aqueous wellbore servicing fluid includes fluids that are comprised entirely or substantially of non-aqueous fluids and/or invert emulsions wherein the continuous phase is a non-aqueous fluid. In an embodiment, the non-aqueous wellbore servicing fluid comprises less than about 45% water by weight of the wellbore servicing fluid. Alternatively, the wellbore servicing fluid may contain a balance of the non-aqueous fluid after taking other components of the fluid composition into account.

In an embodiment, the wellbore servicing fluid comprises an oleaginous fluid. Examples of oleaginous fluids suitable for use in the present disclosure include, but are not limited to petroleum oils, natural oils, synthetically-derived oils, or combinations thereof. More particularly, examples of oleaginous fluids suitable for use in the present disclosure include, but are not limited to, diesel oil, kerosene oil, mineral oil, synthetic oil, such as polyolefins (e.g., alpha-olefins and/or internal olefins), polydiorganosiloxanes, esters, diesters of carbonic acid, paraffins, or combinations thereof.

Examples of oleaginous fluids suitable for use in this disclosure include without limitation PETROFREE® base fluid, which is a synthetic 100% ester base fluid, XP-07™ synthetic paraffin base fluid which is a pure normal alkane mixture all of which are available from Petroleum Carless, Aberdeen; ESCAID 110 hydrocarbon fluid which is a petroleum distillate commercially available from EXXON-MOBIL Corp; ACCOLADE® base comprising esters from Baroid Drilling Fluids; ENCORE® base comprising isomerized olefins, both available from Halliburton Energy Services, Inc.

A wellbore servicing fluid suitable for use in the present disclosure is the INNOVERT® paraffin/mineral based fluid system, available from Baroid, a Halliburton Company. The INNOVERT® paraffin/mineral based fluid system typically comprises the following additives: RHEMOD™ L modified fatty acid suspension and viscosifying agent, BDF-366 or ADAPTA® copolymer for high pressure high temperature (HPHT) filtration control, particularly for use at high temperatures, lime, and EZ MUL® NT polyaminated fatty acid emulsifier/oil wetting agent, also particularly for use at high temperatures. Commercially available INNOVERT drilling fluid systems also typically include TAU-MOD amorphous/fibrous material as a viscosifier and suspension agent. In an embodiment, the wellbore servicing fluid comprises the INNOVERT drilling fluid and a B-FLA of the type disclosed herein. In such embodiments, the use of a HPHT filtration control material (e.g., ADAPTA) is optional.

In an embodiment, the wellbore servicing fluid comprises a water-in-oil emulsion fluid, termed an invert emulsion, comprising an oleaginous continuous phase and a non-oleaginous discontinuous phase. In an embodiment, the oleaginous fluid of the invert emulsion may be of the type previously disclosed herein. The concentration of the oleaginous fluid should be sufficient so that an invert emulsion forms and may be less than about 98% by volume of the invert emulsion. In one embodiment, the amount of oleaginous fluid is from about 30% to about 95% by volume, alternatively about 40% to about 90% by volume of the invert emulsion.

Any aqueous solution containing a water-activity lowering compound, composition or material may comprise the internal phase of the invert emulsion. For example the aqueous solution may comprises a saline solution comprising calcium chloride (typically about 15% to about 30%, depending on the subterranean formation water salinity or activity), although other salts or water-activity lowering materials such as for example glycerol or sugar may alternatively or additionally be used. In an embodiment, the aqueous solution comprises a brine. Examples of suitable brines include, but are not limited to chloride-based, bromide-based, or formate-based brines containing monovalent and/or polyvalent cations and combinations thereof. Examples of suitable chloride-based brines include, but are not limited to sodium chloride and calcium chloride. Examples of suitable bromide-based brines include, but are not limited to, sodium bromide, calcium bromide, and zinc bromide. Examples of suitable formate-based brines include, but are not limited to, sodium formate, potassium formate, and cesium formate. In an embodiment, the drilling fluid has an oil:water ratio ranging from about 50:50 to about 95:5.

In an embodiment, the amount of the non-oleaginous fluid may be present in an amount that is less than the theoretical limit needed for forming an invert emulsion. In an embodiment, the non-oleaginous fluid may be present in an amount of less than about 70% by volume of the invert emulsion, alternatively, from about 1% to about 70% by volume, alternatively, from about 5% to about 60% by volume.

For example, in an embodiment, the invert emulsion may comprise from about 20% to about 60% non-oleaginous fluid by volume and about 40% to 80% oleaginous fluid by volume, alternatively from about 30% to about 50% non-oleaginous fluid by volume and about 50% to 70% oleaginous fluid by volume. In an embodiment, the wellbore servicing fluid comprises an invert emulsion fluid having an oil:water ratio of from about 60:40 to about 90:10, alternatively from about 60:40 to about 70:30, alternatively from about 70:30 to about 80:20, or alternatively from about 80:20 to about 90:10. In an embodiment, the invert emulsion drilling fluid has a density from about 9 pounds per gallon (ppg) to about 18 ppg.

The wellbore servicing fluid may comprise additional additives as deemed appropriate for improving the properties of the fluid. Such additives may vary depending on the intended use of the fluid in the wellbore. Examples of such additives include, but are not limited to, emulsifiers, lime, organic/inorganic viscosifiers, weighting agents, glass fibers, carbon fibers, suspending agents, conditioning agents, dispersants, water softeners, oxidation and corrosion inhibitors, thinners, acid gas scavengers and combinations thereof. These additives may be introduced singularly or in combination using any suitable methodology and in amounts effective to produce the desired improvements in fluid properties. In an embodiment, the wellbore servicing fluid is clay-free, such that the fluid is substantially free of an organoclay. Alternatively, the wellbore servicing fluid excludes organoclay. In an embodiment, organoclay is present in the wellbore servicing fluid in concentration of less than 3 pounds per barrel of the wellbore servicing fluid, alternatively less than about, 3, 2, or 1 wt. % which may enter the wellbore servicing fluid as a result of mixing of the organoclay and organoclay-free invert emulsion fluids.

In an embodiment, the B-FLA is present in the wellbore servicing fluid (e.g., invert emulsion fluid) in an amount of 5pounds per barrel (ppb) of the B-FLA alternatively from about 0.5 ppb to about 20 ppb. In an embodiment, a wellbore servicing fluid suitable for use in the present disclosure comprises a B-FLA present in an amount of from about 2 ppb to about 5 ppb. In an embodiment, a wellbore servicing fluid suitable for use in the present disclosure comprises a B-FLA present in an amount of about 5 ppb and an invert emulsion drilling fluid having an OWR of 70:30. In an embodiment, a wellbore servicing fluid suitable for use in the present disclosure comprises an esterquat present in an amount of about 5 ppb and an invert emulsion drilling fluid having an OWR of 70:30.

In an embodiment, a wellbore servicing fluid suitable for use in the present disclosure comprises an esterquat characterized by general formula I where R₁, and R₂ are methyl and R₃ and R₄ comprise from 16 to 18 carbon atoms and an invert emulsion drilling fluid having an OWR of from about 60:40 to about 90:10. In an embodiment, a wellbore servicing fluid suitable for use in the present disclosure comprises an invert emulsion drilling fluid comprising ESCAID 110 and XP-07 as base oils.

A wellbore servicing fluid (e.g., invert emulsion fluid) containing a B-FLA of the type disclosed herein can be placed into a wellbore and used to service the wellbore in accordance with suitable procedures. For example, the wellbore servicing fluid can be circulated down through a hollow drill stem and out through a drill bit attached thereto while rotating the drill stem to thereby drill the wellbore. The drilling fluid can be flowed back to the surface such as to deposit a filter cake on the walls of the wellbore and to continuously carry drill cuttings to the surface. The B-FLA may be included in the wellbore servicing fluid prior to the fluid being placed downhole in a single stream embodiment. Alternatively, the B-FLA may be mixed with the other components of the wellbore servicing fluid during placement into the wellbore, for example, in a two-stream process wherein one stream comprises the B-FLA and a second stream comprises the other components of the wellbore servicing fluid. In an embodiment, the wellbore servicing fluid comprising the B-FLA is prepared at the wellsite. For example, the B-FLA may be mixed with the other wellbore servicing fluid components and then placed downhole. Alternatively, the wellbore servicing fluid comprising the B-FLA is prepared offsite and transported to the use site before being placed downhole.

In an embodiment, a wellbore servicing fluid comprising an oil-based mud (e.g., invert emulsion fluid) and a B-FLA of the type disclosed herein results in a reduction of fluid loss of the WSF where the fluid loss may be determined using a high-temperature high-pressure fluid loss test (HTHP) carried out in accordance with the Specification for Drilling Fluids Materials, ANSI/API Specification 13A, Eighteenth Edition, February 2010.

### EXAMPLES

The disclosure having been generally described, the following examples are given as particular embodiments of the disclosure and to demonstrate the practice and advantages thereof. It is understood that the examples are given by way of illustration and are not intended to limit the specification or the claims in any manner.

### Example 1

The effect of a B-FLA of the type disclosed herein on the fluid loss properties of different invert emulsion fluids (IEF) was investigated. High performance clay free INNOVERT® fluids were prepared as per the formulations presented in Tables 1 and 2. All formulations were prepared using an IEF having a 70:30 oil:water ratio and a density of 12 pounds per gallon (ppg). The samples shown in Table 1 were prepared using ESCAID® 110 as a base fluid while the samples shown in Table 2 used XP-07 as a base fluid. Fluid #1 and Fluid #5 shown in Tables 1 and 2 respectively refer to samples that did not contain a fluid loss additive. The sample designated Fluid #2 and Fluid #6 in Tables 1 and 2 respectively contained ADAPTA® as the fluid loss additive. ADAPTA® filtration control agent is a cross-linked polymer commercially available from Baroid. The samples designated Fluid #3 and Fluid #7 in Tables 1 and 2 respectively contained VARISOFT® EQ 65 as the fluid loss agent. The sample designated Fluid #7 in Table 2 contained VARISOFT® EQ 65 as the fluid loss agent and a minimal amount of REV DUST®. REV DUST® is added to simulate the drill solids encountered in a typical drilling operation, it is commercially available from Milwhite Inc. EZ MUL® NT emulsifier is a invert emulsifier and oil-wetting agent; RHEMOD™ L viscosifier is a liquid additive and BARITE heavyweight additive is a barium sulfate material; all of which are commercially available from Halliburton Energy Services. The results demonstrate the ability of VARISOFT® EQ65 to reduce fluid loss in an IEF. FANN rheology measurements carried out on the formulations of Table 2 which used XP-07 as the base fluid demonstrated the samples containing a B-FLA of the type disclosed herein (e.g., VARISOFT® EQ 65) displayed a rheological profile similar to the samples containing a conventional FLA (e.g., ADAPTA®).

TABLE 1

| Components in | | | | |
|---|---|---|---|---|
| order of addition | Fluid#1 | Fluid#2 | Fluid#3 | Fluid#4 |
| ESCAID-110, ppb | 152.6 | 152.6 | 152.6 | 152.6 |
| EZ MUL ® NT, ppb | 3 | 3 | 3 | 3 |
| LIME, ppb | 1.5 | 1.5 | 1.5 | 1.5 |
| RHEMOD ™ L, ppb | 3 | 3 | 3 | 3 |
| ADAPTA ®, ppb | 0 | 2 | 0 | 0 |
| VARISOFT ® EQ 65, ppb | 0 | 0 | 5 | 5 |
| 97% Calcium Chloride, ppb | 29.3 | 29.3 | 29.3 | 29.3 |
| Water, ppb | 84.4 | 84.4 | 84.4 | 84.4 |
| Drill Solids, ppb | 20 | 20 | 20 | 5 |
| Barite, ppb | 210.1 | 210.1 | 210.1 | 210.1 |
| Hot roll temperature ° F. | 250 | 250 | 250 | 250 |
| Mud weight, ppg | 12 | 12 | 12 | 12 |
| HTHP filtrate at 250 ° F., ml | 24 | 3.0 | 2.0 | 2.4 |

ppb = pounds per barrel
ppg = pounds per gallon

TABLE 2

| Components in order | | | |
|---|---|---|---|
| of addition | Fluid#5 | Fluid#6 | Fluid#7 |
| XP-07, ppb | 144.6 | 144.6 | 143.3 |
| EZ MUL ® NT, ppb | 8 | 8 | 8 |
| LIME, ppb | 1.5 | 1.5 | 1.5 |
| RHEMOD ™ L, ppb | 3 | 3 | 3 |
| VARISOFT ® EQ 65, ppb | 0 | 0 | 5 |
| ADAPTA ®, ppb | 0 | 1.5 | 0 |
| 97% Calcium Chloride, ppb | 29.1 | 29.1 | 29.1 |
| Water, ppb | 83.8 | 83.8 | 83.8 |
| Drill Solids, ppb | 20 | 20 | 20 |
| Barite, ppb | 213.2 | 213.2 | 210.5 |
| Hot roll temperature, ° F. | 250 | 250 | 250 |
| Mud weight, ppg | 12 | 12 | 12 |

FANN 35 Rheology at 120° F.

| | | | |
|---|---|---|---|
| 600 rpm | 48 | 45 | 69 |
| 300 rpm | 30 | 29 | 44 |
| 200 rpm | 22 | 22 | 34 |
| 100 rpm | 15 | 15 | 24 |
| 6 rpm | 5 | 6 | 10 |
| 3 rpm | 3 | 5 | 9 |
| 10 Sec gel lbs/100 ft² | 3 | 5 | 11 |
| 10 min gel lbs/100 ft² | 4 | 5 | 20 |
| PV cp | 18 | 16 | 25 |
| YP lb/100 ft² | 12 | 13 | 19 |
| HTHP filtrate at 250 ° F., ml | 8.0 | 3.7 | 3.6 |

While embodiments of the disclosure have been shown and described, modifications thereof can be made by one skilled in the art without departing from the spirit and teachings of the disclosure. The embodiments described herein are exemplary only, and are not intended to be limiting. Many variations and modifications of the disclosure disclosed herein are possible and are within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R_{L}, and an upper limit, R_{U}, is disclosed, any number falling within the range is specifically disclosed. In particular, the following numbers within the range are specifically disclosed: R=R_{L}+k*(R_{U}−R_{L}), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present disclosure. Thus, the claims are a further description and are an addition to the embodiments of the present disclosure. The discussion of a reference is not an admission that it is prior art to the present disclosure, especially any reference that may have a publication date after the priority date of this application. The disclosures of all patents, patent applications, and publications cited herein are hereby incorporated by reference, to the extent that they provide exemplary, procedural, or other details supplementary to those set forth herein.

What is claimed is:

1. A method of servicing a wellbore comprising placing an invert emulsion drilling fluid having an oleaginous continuous phase, a non-oleaginous discontinuous phase, and a fluid loss additive into a wellbore wherein the fluid loss additive comprises a quaternary ammonium compound containing at least one ester linkage.

2. The method of claim 1 wherein the drilling fluid is substantially free from organophilic clay.

3. The method of claim 1 wherein the quaternary ammonium compound comprising at least one ester linkage is characterized by the general formula: 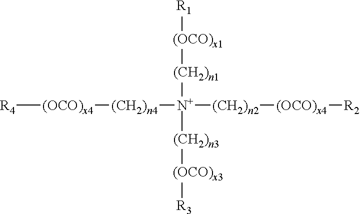
wherein R₁, R₂, R₃ and R₄ are each independently selected from the group consisting of hydrogen; hydroxyl groups; saturated or unsaturated alkyl groups; aromatic groups; cyclic alkyl groups; alkyl-aryl groups; heterocyclic groups; and sugar groups containing from about 1 to about 36 carbon atoms;
wherein at least two of the R groups each comprise more than 12 carbon atoms;
wherein A⁻ is selected from the group consisting of halide ions, sulfate ions, sulfonate ions, nitrate ions, carboxylate ions, hydroxyl ions and phosphate ions; and
wherein x₁, x₂, x₃, and x₄ each have a value from about 0 to about 1 and n₁, n₂, n₃, and n₄ each have a value of from about 0 to about 18.

4. The method of claim 3 wherein when any, but not more than two of, n₁, n₂, n₃, or n₄ is zero at any one time, then a corresponding x₁, x₂, x₃, or x₄ is zero and wherein when any of R₁, R₂, R₃ or R₄ is a hydrogen and a corresponding x₁-n₁, x₂-n₂, x₃-n₃, or x₄-n₄ pair is zero the nitrogen is directly bonded to hydrogen.

5. The method of claim 3 wherein any, but not all of x₁, x₂, x₃, or x₄ is zero at the same time and a corresponding R₁, R₂, R₃ or R₄ each independently bonds directly to the carbon of a corresponding (CH₂)ₙ.

6. The method of claim 1 wherein the quaternary ammonium compound comprising at least one ester linkage is characterized by the general formula: 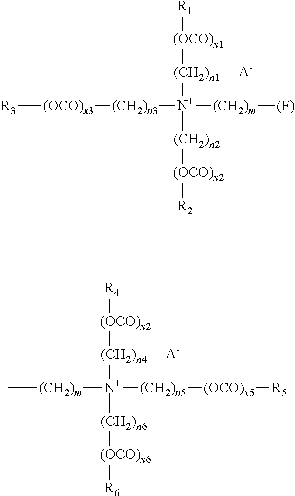
wherein R₁, R₂, R₃, R₄, R₅ and R₆ are each independently selected from the group consisting of hydrogen; hydroxyl groups; saturated or unsaturated alkyl groups; cyclic alkyl groups; aromatic groups; alkyl-aryl groups; heterocyclic groups; and sugar groups containing from about 1 to about 36 carbon atoms;
wherein at least two of the R groups each comprise more than 12 carbon atoms;
wherein A− is selected from the group consisting of halide ions sulfate ions, sulfonate ions, nitrate ions, carboxylate ions, hydroxyl ions and phosphate ions;
wherein each F is independently selected from the group consisting of an ester group, an ether group, an amide group, an imide group, an amine group, a ketonic group, heterocyclic group, a cyclic alkyl group, an unsaturated alkyl group, an aryl group, or a sugar group;
and wherein x₁, x₂, x₃, x₄, x₅, and x₆ each have a value from about 0 to about 1; and n₁, n₂, n₃, n₄, n₅, n₆, or m each have a value of from about 0 to about 18.

7. The method of claim 6 wherein when any, but not more than four of, n₁, n₂, n₃, n₄, n₅, or n₆ is zero at any one time then a corresponding x₁, x₂, x₃, x₄, x₅, or x₆ is zero and wherein when any of R₁, R₂, R₃, R₄, R₅ or R₆ is a hydrogen and a corresponding x₁-n₁, x₂-n₂, x₃-n₃, x₄-n₄, x₅-n₅, or x₆-n₆ pair is zero the nitrogen is directly bonded to hydrogen.

8. The method of claim 6 wherein any, but not all of, x₁, x₂, x₃, x₄, x₅, or x₆ is zero at the same time and a corresponding R₁, R₂, R₃, R₄, or R₅ independently bonds directly to the carbon of a corresponding (CH₂)ₙ.

9. The method of claim 1 wherein the quaternary ammonium compound comprising at least one ester linkage is characterized by the general formula: 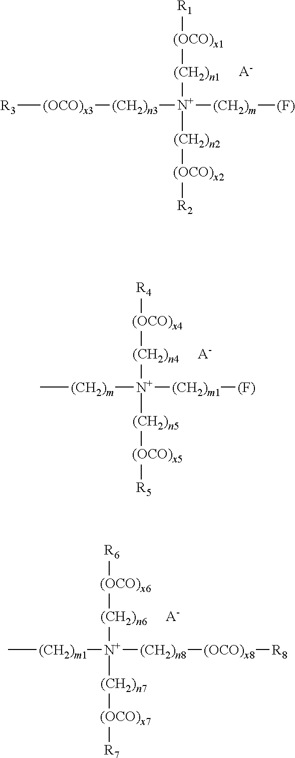
where R₁, R₂, R₃ R₄, R₅, R₆, R₇ and R₈ are each independently selected from the group consisting of hydrogen; hydroxyl groups; saturated or unsaturated alkyl groups; cyclic alkyl groups; aromatic groups; alkyl-aryl groups; heterocyclic groups; and sugar groups containing from about 1 to about 36 carbon atoms;
wherein at least three of the R groups each comprise more than 12 carbon atoms;
wherein A− is selected from the group consisting of halide ions sulfate ions, sulfonate ions, nitrate ions, carboxylate ions, hydroxyl ions and phosphate ions;
each F is independently selected from the group consisting of an ester group, an ether group, an amide group, an imide group, an amine group, a ketonic group, heterocyclic group, a cyclic alkyl group, an unsaturated alkyl group, an aryl group, and a sugar group;
and wherein x₁, x₂, x₃, x₄, x₅, x₆, x₇ and x₈ each have a value from about 0 to about 1; and n₁, n₂, n₃, n₄, n₅, n₆, n₇, n₈, m and m₁ each have a value of from about 0 to about 18.

10. The method of claim 9 wherein when any, but not more than five of, n₁, n₂, n₃, n₄, n₅, n₆, n₇, or n₈ is zero at any one time then a corresponding x₁, x₂, x₃, x₄, x₅, x₆, x₇ or x₈ is zero and wherein when any of R₁, R₂, R₃ R₄, R₅, R₆, R₇ or R₈ is a hydrogen and a corresponding x₁-n₁, x₂-n₂, x₃-n₃, x₄-n₄, x₅-n₅, x₆-n₆, x₇-n₇, or x₈-n₈ pair is zero the nitrogen is directly bonded to hydrogen.

11. The method of claim 9 wherein any, but not all of, x₁, x₂, x₃, x₄, x₅, x₆, x₇ or x₈ is zero at the same time and a corresponding R₁, R₂, R₃ R₄, R₅, R₆, R₇ or R₈ independently bonds directly to the carbon of a corresponding (CH₂)n.

12. The method of claim 1 wherein the esterquat provides at least 60% biodegradability in 28 days as determined in accordance with OECD 301B.

13. The method of claim 1 wherein the esterquat is present in the composition in an amount of from about 0.5 ppb to about 20 ppb.

14. The method of claim 1 wherein the invert emulsion drilling fluid has a density from about 9 to about 18 ppg.

15. The method of claim 1 wherein the oleaginous continuous phase comprises petroleum oil, natural oil, synthetically derived oil, an alpha olefin, an internal olefin, an ester, a diester of carbonic acid, a paraffin, kerosene oil, diesel oil, mineral oil or combinations thereof.

16. The method of claim 1 wherein invert emulsion drilling fluid has an oil water ratio from about 50:50 to about 95:5.

17. The method of claim 1 wherein the non-oleaginous discontinuous phase comprises an aqueous solution of a water activity lowering material selected from the group consisting of sugar; glycerol; salts selected from the group consisting of calcium chloride, calcium bromide, sodium chloride, sodium bromide, formate, and combinations thereof.

18. A method of servicing a wellbore comprising introducing a clay-free invert emulsion drilling fluid comprising distearoylethyl dimonium chloride to the wellbore.

19. The method of claim 18 wherein the invert emulsion fluid comprises petroleum oil, natural oil, synthetically derived oil, an alpha olefin, an internal olefin, an ester, a diester of carbonic acid, a paraffin, kerosene oil, diesel oil, mineral oil or combinations thereof.

20. The method of claim 18 wherein the aqueous solution contains a water activity lowering material selected from the group consisting of sugar; glycerol; salts selected from the group consisting of calcium chloride, calcium bromide, sodium chloride, sodium bromide, formate, and combinations thereof.

21. The method of claim 18 wherein the invert emulsion drilling fluid has an oil:water ratio of from about 60:40 to about 90:10.

22. A wellbore servicing fluid comprising an invert emulsion drilling fluid having an oleaginous continuous phase, a non-oleaginous discontinuous phase, and a fluid loss additive into a wellbore wherein the fluid loss additive comprises an esterquat characterized by Structure A: [chemical structure]
